(19) United States
(12) Patent Application Publication
(10) Pub. No.: US 2026/0113117 A1
(43) Pub. Date: Apr. 23, 2026

(54) Out-of-Band Pairing and Provisioning for Bluetooth Devices

(71) Applicant: Silicon Laboratories Inc., Austin, TX (US)

(72) Inventors: Hannu Mallat, Hyvinkaa (FI); Jori Rintahaka, Espoo (FI)

(21) Appl. No.: 18/924,792

(22) Filed: Oct. 23, 2024

(51) Int. Cl. H04B 10/116; H04L 1/00; H04W 76/14; H04W 84/18

(52) U.S. Cl. CPC H04B 10/116; H04L 1/0061; H04W 76/14; H04W 84/18

(57) ABSTRACT

A system and method of allowing a new device to join an existing network are disclosed. The new device comprises a multi-color light, such as a RGB LED. The out of band (OOB) messages are encoded using transitions between the different LED states. In addition, the OOB message may be formatted using TLVs (type-length-value). Cyclic Redundancy Codes and forward error correction can also be included in the OOB Message. This OOB message can be easily incorporated in Bluetooth LE Secure Connections or into Bluetooth Mesh provisioning.

### FIELD

This disclosure describes systems and methods allowing new devices to securely join a Bluetooth network.

### BACKGROUND

The explosion of network connected devices has led to an increased use of smart networks, and particularly Bluetooth networks.

One issue associated with all of these Bluetooth networks is the need to provide security. The communications over the Bluetooth network should be encrypted such that other listening devices cannot decode the network traffic. In other words, these devices must have a cryptographic key or password to allow them to decode encrypted communications over the network.

In Bluetooth LE, the process of creating this cryptographic bond between the new device and the network device is referred to as pairing. The pairing process forms a cryptographic key that is shared by both devices, and is a prerequisite for securing the connection between the two devices from eavesdropping and attacks that manipulate the data being transmitted. The key created during the pairing process will be used to secure communications between the two devices only, and not in a wider scope. This one-to-one bonding may be considered a two-device network.

In Bluetooth Mesh, this equivalent process is referred to as provisioning. In the provisioning process, the new mesh device is made part of a network by securely distributing an initial set of credentials to the new device.

Pairing may be authenticated or unauthenticated. In the unauthenticated case, there is no protection against a man-in-the-middle attack. Even if the unauthenticated pairing process is secured against passive eavesdropping by malicious third parties, it is not secured against an active attacker inserting themselves between the two devices as a proxy that can manipulate the traffic passing through it.

Authenticated pairing requires either some pre-shared credentials that are not known to a third party, or an exchange of dynamically generated authentication data delivered out-of-band. The term “out-of-band” or OOB implies that the data is not carried over the Bluetooth communications channel, but rather over some other channel.

Typical examples of pre-shared credentials include QR codes printed on devices or static NFC tags with hardcoded data. The data is encoded into the device itself (for example, on flash storage) and the QR or NFC representation of that same data can be read by the other device provided it has the suitable hardware to do so, such as a camera or a NFC reader. Pre-shared credentials are typically static (generated once and not changed afterwards) in nature.

Typical examples of dynamically generated authentication data include numeric or alphanumeric passcodes that are generated and displayed on one device, and read by the other device or input to the other device by the user, such as by means of a physical or a virtual keyboard.

Static credentials have the risk of being leaked, in which case they no longer provide any security. Dynamically created authentication data is better in this regard, and it is created anew anytime it is needed, so it cannot be leaked beforehand.

Dynamically created authentication data however needs to be communicated somehow between devices. This means that one device needs to have the means to somehow output the code and the other device either needs to have the means to read and interpret the code, or have the user input the code. The hardware required to display a numeric or alphanumeric code can be bulky and costly, especially if the device has no other need for such a display. User input can be unreliable or irritating to the user, especially when the passcode is an unnatural mix of numbers and characters.

All of these scenarios also apply to the provisioning process. Furthermore, none of these scenarios are straightforward.

Therefore, an improved system and method of allowing a new device to securely join a Bluetooth LE or Bluetooth Mesh network is needed. Further, it would be beneficial if this system and method was simple to implement so as to be easily accomplished by battery powered devices.

### SUMMARY

A system and method of allowing a new device to join an existing network are disclosed. The new device comprises a multi-color light, such as a RGB LED. The out of band (OOB) messages are encoded using transitions between the different LED states. In addition, the OOB message may be formatted using TLVs (type-length-value). Cyclic Redundancy Codes and forward error correction can also be included in the OOB Message. This OOB message can be easily incorporated in Bluetooth LE Secure Connections or into Bluetooth Mesh provisioning.

According to one embodiment, a method of allowing a joining device to join a Bluetooth network is disclosed. The method comprises transmitting from the joining device, an out of band (OOB) message containing device specific information associated with the joining device, wherein the joining device utilizes a multi-color light transmitter to transmit the OOB message, and wherein the OOB message is encoded by transitions in a state of the multi-color light transmitter; receiving, at the network device, the OOB message; and using information in the OOB message to perform a joining process. In some embodiments, the multi-color light transmitter comprises a red green blue (RGB) LED, wherein there are at least 8 LED states. In certain embodiments, 8 LED states are used, which create 7 possible transitions, and all data in the OOB message is encoded using base-7. In some embodiments, each color component of the RGB LED has at least three states; an on state, an off state and at least one state between the on state and the off state; and wherein there are at least 27 LED states. In some embodiments, prior to transmitting the OOB message, the joining device transmits a calibration sequence to allow the network device to calibrate a camera. In some embodiments, the OOB message is structured as a plurality of TLVs (type-length-value). In some embodiments, the OOB message includes a cyclic redundancy code. In some embodiments, the OOB message is encoded using a forward error correction (FEC) mechanism. In some embodiments, the network device queries GATT services in the joining device to determine if the joining device is capable of transmitting the OOB message.

In some embodiments, the Bluetooth network comprises a Bluetooth LE network and the joining process comprises a LE Secure Connections pairing process. In certain embodiments, the network device transmits a GATT request to the joining device to initiate transmission of the OOB message.

In some embodiments, the Bluetooth network comprises a Bluetooth Mesh network and the joining process comprises a provisioning process. In certain embodiments, the joining device transmits the OOB message to the network device after the network device transmits a Provisioning Start PDU to the joining device.

According to another embodiment, a Bluetooth system is disclosed. The system comprises a network device comprising a camera; and a joining device comprising a multi-color light transmitter; wherein the joining device is configured to transmit an OOB message using the multi-color light transmitter; wherein the data is encoded by transitions in a state of the multi-color light transmitter; wherein the network device is configured to receive the OOB message using the camera; and wherein information in the OOB message is used by the network device to perform a joining process. In some embodiments, the OOB message transmitted by the joining device is structured as a plurality of TLVs (type-length-value). In some embodiments, the multi-color light transmitter comprises a RGB LED, wherein there are at least 8 LED states. In certain embodiments, 8 LED states are used, which create 7 possible transitions, and all data in the OOB message transmitted by the joining device is encoded using base-7. In some embodiments, the OOB message includes a cyclic redundancy code. In some embodiments, the OOB message is encoded using a forward error correction (FEC) mechanism.

### BRIEF DESCRIPTION OF THE DRAWINGS

For a better understanding of the present disclosure, reference is made to the accompanying drawings, in which like elements are referenced with like numerals, and in which:

FIG. 1 is a block diagram of a network device that is part of the network;

FIG. 2 is a block diagram of the new device that wishes to join the network;

FIG. 3 shows the states of an RGB LED;

FIG. 4 shows one possible encoding scheme using an RGB LED;

FIG. 5 shows a sequence used to generate and transmit a OOB message;

FIG. 6 shows a sequence used to receive and decode an OOB message;

FIGS. 7A-7C show the pairing process using Bluetooth LE Secure Connections; and

FIGS. 8A-8C show the provisioning process using Bluetooth Mesh.

### DETAILED DESCRIPTION

According to one embodiment, the system and method described herein typically involve two devices; the new device that wishes to join the network, also referred to as the joining device; and a device that is currently on the network and is able to be in proximity of the joining device, also referred to as the network device. This system and method require that the joining device, which is typically resource constrained, includes a single RGB LED. Further, the network device includes means to view the output from the RGB LED, such as a camera.

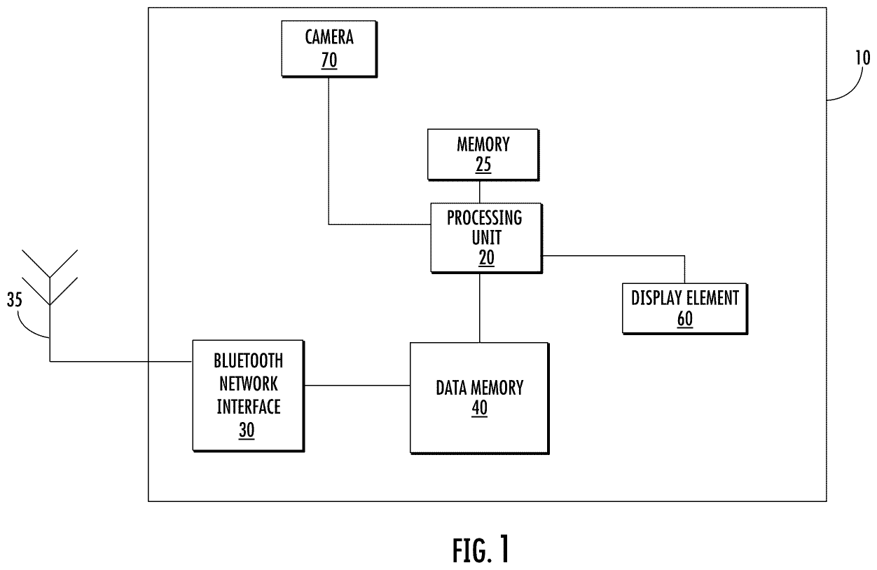

The network may comprise a plurality of network devices. These network devices may be various types, such as door locks, lights, light switches, appliances, thermostats, phones, and personal computers. One of these network devices may be used to facilitate the joining process for a new device. FIG. 1 shows a block diagram of a representative network device 10. In some embodiments, the network device 10 may be a mobile device, such as a mobile phone or a tablet.

The network device 10 has a processing unit 20 and an associated memory device 25. This memory device 25 contains the instructions, which, when executed by the processing unit 20, enable the network device 10 to perform the functions described herein. This memory device 25 may be a non-volatile memory, such as a FLASH ROM, an electrically erasable ROM or other suitable devices. In other embodiments, the memory device 25 may be a volatile memory, such as a RAM or DRAM. In certain embodiments, the memory device 25 may be packaged with the processing unit 20. The processing unit 20 may be any suitable device, including but not limited to a general purpose processor, an application specific processor, an embedded controller, or a personal computer (PC).

The network device 10 also includes a Bluetooth network interface 30, which is a wireless interface including an antenna 35. This Bluetooth network interface 30 is used to communicate over the Bluetooth network.

The network device 10 may include a data memory device 40 in which data that is received by the Bluetooth network interface 30, and data that is to be transmitted by the Bluetooth network interface 30, is stored. This data memory device 40 is traditionally a volatile memory. The processing unit 20 has the ability to read and write the data memory device 40 so as to communicate with the other devices in the network. Although not shown, the network device 10 also has a power supply, which may be a battery or a connection to a permanent power source, such as a wall outlet.

While a memory device 25 is disclosed, any computer readable medium may be employed to store these instructions. For example, read only memory (ROM), a random access memory (RAM), a magnetic storage device, such as a hard disk drive, or an optical storage device, such as a CD or DVD, may be employed. Furthermore, these instructions may be downloaded into the memory device 25, such as for example, over a network connection (not shown), via CD ROM, or by another mechanism. These instructions may be written in any programming language and that language is not limited by this disclosure. Thus, in some embodiments, there may be multiple computer readable media that contain the instructions described herein. The first computer readable media may be in communication with the processing unit 20, as shown in FIG. 1. The second computer readable media may be a CDROM, or a different memory device, which is located remote from the network device 10. The instructions contained on this second computer readable media may be downloaded onto the memory device 25 to allow execution of the instructions by the network device 10.

The network device 10 may also include a display element 60. In some embodiments, the display element 60 may be a LED or LCD screen. In certain embodiments, the display element 60 is a touch screen so that input may be supplied to the processing unit 20 through the display element 60. In other embodiments, the network device 10 may also be in communication with a separate input device to allow user entry. The input device may be a keyboard, for example.

The network device 10 also includes a camera 70. The camera 70 may include a plurality of pixels that capture visual images. While the disclosure uses the term “camera”, it is understood that any photodetector may be used. The processing unit 20 is in communication with the camera 70 so as to be aware of any light. In certain embodiments, the network device 10 is capable of video recording so as to capture an entire sequence transmitted by the joining device.

In one specific embodiment, the network device 10 may be a mobile telephone or tablet computer. In certain embodiments, the instructions described herein may be packaged as an application. The network device 10 may receive the application from a remote server. For example, in one embodiment, an application may be made available on a remote server, such as a corporate server. In certain embodiments, the application may be available on a digital distribution platform, such as Google Play, Microsoft Store, the Apple App Store and others. Of course, in other embodiments, the software application may be pre-loaded onto the network device 10.

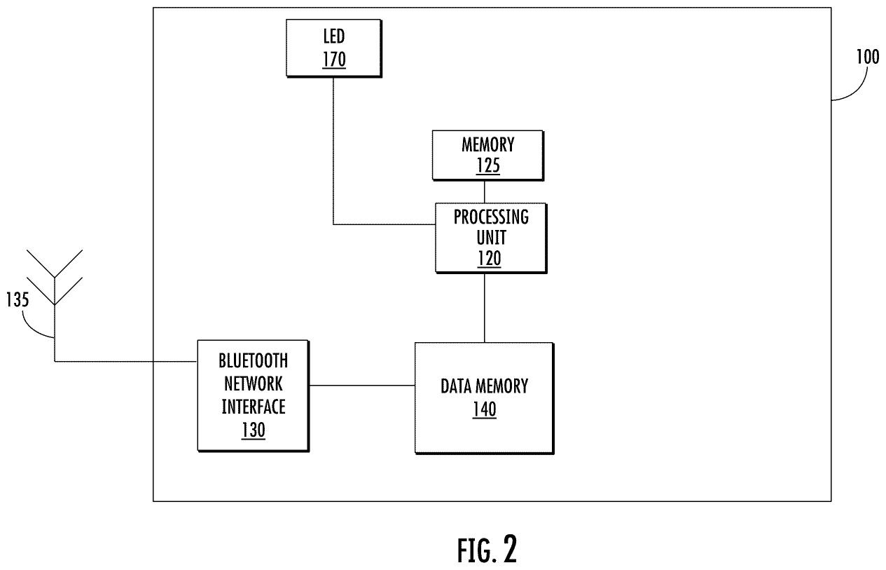

FIG. 2 shows a representative schematic of the joining device 100. The joining device 100 has a processing unit 120 and an associated memory device 125. This memory device 125 contains the instructions, which, when executed by the processing unit 120, enable the joining device 100 to perform the functions described herein. This memory device 125 may be a non-volatile memory, such as a FLASH ROM, an electrically erasable ROM or other suitable devices. In other embodiments, the memory device 125 may be a volatile memory, such as a RAM or DRAM. In certain embodiments, the memory device 125 may be packaged with the processing unit 120. The processing unit 120 may be any suitable device, including but not limited to a general purpose processor, an application specific processor, an embedded controller, or a personal computer (PC).

The joining device 100 also includes a Bluetooth network interface 130, which is a wireless interface including an antenna 135.

The joining device 100 may include a data memory device 140 in which data that is received by the Bluetooth network interface 130, and data that is to be transmitted by the Bluetooth network interface 130, is stored. This data memory device 140 is traditionally a volatile memory. The processing unit 120 has the ability to read and write the data memory device 140 so as to communicate with the other devices in the network. Although not shown, the joining device 100 also has a power supply, which may be a battery or a connection to a permanent power source, such as a wall outlet.

While a memory device 125 is disclosed, any computer readable medium may be employed to store these instructions. For example, read only memory (ROM), a random access memory (RAM), a magnetic storage device, such as a hard disk drive, or an optical storage device, such as a CD or DVD, may be employed. Furthermore, these instructions may be downloaded into the memory device 125, such as for example, over a network connection (not shown), via CD ROM, or by another mechanism. These instructions may be written in any programming language and the language is not limited by this disclosure. Thus, in some embodiments, there may be multiple computer readable media that contain the instructions described herein. The first computer readable media may be in communication with the processing unit 120, as shown in FIG. 2. The second computer readable media may be a CDROM, or a different memory device, which is located remote from the joining device 100. The instructions contained on this second computer readable media may be downloaded onto the memory device 125 to allow execution of the instructions by the joining device 100.

The joining device 100 may also include a light source 170. The light source 170 may include one or more multi-color light emitting diodes (LEDs), such as red-green-blue (RGB) LEDs, that emit light that can be seen outside the joining device 100. The light may be emitted in the visible spectrum.

Note that the network device 10 and the joining device 100 do not have a shared clock, so any communication that relies on pulse width or duration may be problematic. A better approach may be to rely on the transitions between states, rather than the duration of any particular state.

For example, using a RGB LED, there are eight possible LED states that the joining device 100 may generate when each of the color components is either fully on or fully off:
White;
Yellow;
Magenta;
Red;
Cyan;
Green;
Blue; and
Off.

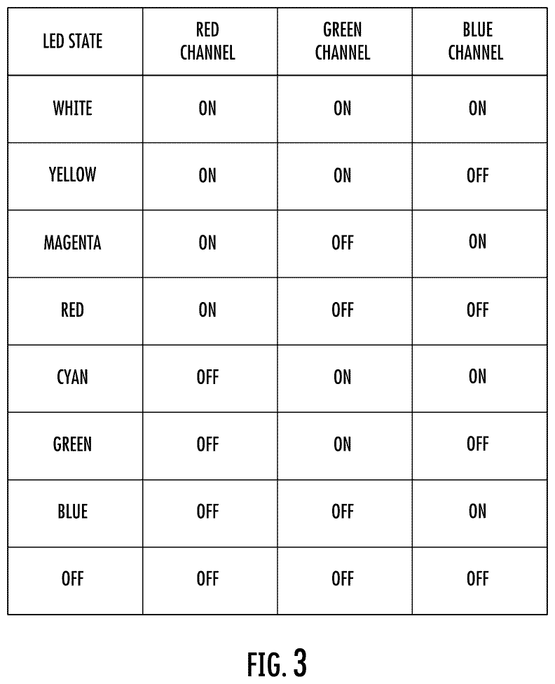

The configuration of the channels of the RGB LED in the joining device 100 to create each of these outputs is shown in FIG. 3.

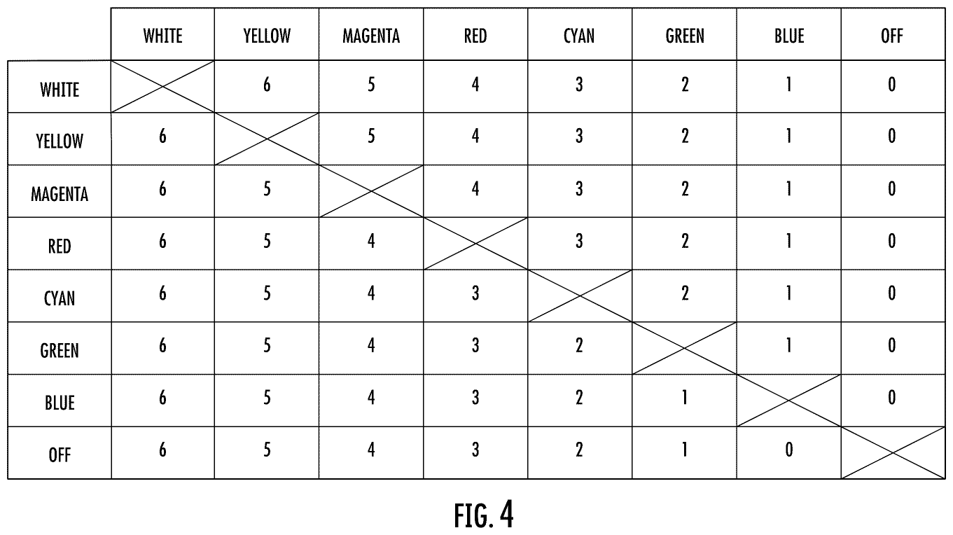

Since there are eight LED states, there are seven possible transitions from each LED state. Thus, there are seven symbols in this encoding, each symbol may be assigned a numerical value between 0 and 6. In this way, all data to be transmitted may be encoded as a base-7 stream. FIG. 4 shows one possible encoding of the LED state transitions.

To demonstrate this encoding scheme, assume that the current LED state is red. Further assume that there is a need to transmit a sequence of four base-7 numbers (1, 2, 5, 0), that correspond to the decimal value of 476 (1*7³+2*7²+5*7¹+0*7⁰). This would encode as follows:
Red→Blue (to encode 1);
Blue→Cyan (to encode 2);
Cyan→Yellow (to encode 5); and
Yellow→Off (to encode 0).

Note that this base-7 encoding allows about 2.8 bits to be encoded in each transition. Thus, a digital sequence of 128 bits may be transmitted using about 46 LED state transitions. Similarly, a digital sequence of 256 bits may be transmitted using about 92 LED state transitions.

Note that the number of transmissions may be decreased if the joining device 100 has two RGB LEDs. If it is assumed that both RGB LEDs must change state during each transition, there are 7*7=49 distinct values per LED state transition. A joining device 100 with three RCB LEDs may generate 7*7*7=343 different values per LED state transition. However, the use of multiple RGB LEDs requires that they be spaced far enough apart so that the network device 10 may distinguish them. Further, a calibration sequence may be used to allow the network device 10 to determine the proper orientation of the multiple LEDs. For example, the LEDs may appear left to right in one orientation, but are right to left if the joining device 100 is rotated. A unique sequence transmitted by the joining device 100 may be used to ensure proper orientation.

Further, while this disclosure describes the use of seven possible transitions and transmits data using base-7, other embodiments are possible. For example, in one embodiment, only five LED states are used, allowing four possible transitions. This means that all data would be transmitted using base-4, which is a simple conversion from a typical binary stream.

In another embodiment, a more fine-grained control of the RGB LED state allows the use of in-between intensities for each color component. For example, using three intensities (fully off; half; and fully on) would allow 27 LED states instead of 8, and consequently 26 transitions instead of 7. In such a scheme, data would be transmitted using base-26 encoding, and less transitions would be needed to transmit data than with base-7 encoding.

In certain embodiments, it may be desirable to include forward error correction capability. This may be applied to this encoding scheme. For example, a generator matrix may be used to convert 6 data symbols (which are all base-7) into 8 encoded symbols. In one embodiment, the generator matrix may be as follows:

$$[ \begin{matrix}1 & 0 & 0 & 0 & 0 & 0 & 1 & 5 \\ 0 & 1 & 0 & 0 & 0 & 0 & 1 & 6 \\ 0 & 0 & 1 & 0 & 0 & 0 & 2 & 4 \\ 0 & 0 & 0 & 1 & 0 & 0 & 3 & 3 \\ 0 & 0 & 0 & 0 & 1 & 0 & 4 & 2 \\ 0 & 0 & 0 & 0 & 0 & 1 & 5 & 1\end{matrix} ]$$

The corresponding parity check matrix may be:

$$[ \begin{matrix}1 & 0 & 1 & 1 & 1 & 1 & 1 & 1 \\ 0 & 1 & 1 & 2 & 3 & 4 & 5 & 6\end{matrix} ]$$

The encoding process for this code is essentially a matrix multiplication operation. For decoding, a small code such as this may be easily decoded with syndrome decoding as there are only 48 syndromes to check against if the parity check fails. Other codes may be utilized as well, depending on the expected number and type of transmission errors.

Thus, the joining device 100 uses the generator matrix to generate 8 encoded data symbols for each six data symbols. The network device 10 uses the parity check matrix to detect and correct transmission errors.

The matrices above can be used to correct a single error within the received 8 encoded symbols and can thus be used when symbol error probability is relatively low. The transmission efficiency when using this code is 0.75, as 6 out of 8 transmitted symbols carry the data while the 2 error correcting symbols are overhead.

Note that encoding for error correction, even when using a more complex code, can usually be easily done on a limited resource device such as the joining device 100 is likely to be. Decoding takes in general more resources, but in this arrangement the network device 10 often is a device that has ample computing resources, such as a mobile phone or a tablet.

In some embodiments, it may be beneficial to perform a calibration sequence. The calibration sequence may be, for instance, a stream of transitions sent by the joining device 100 that make the RGB LED alternate between a given sequence of states, such as White to Off and back again. The network device 10 can use the intensity difference between White and Off LED states to set camera exposure, and use the color tint of the White signal to set camera white balance. As noted above, if the joining device 100 has multiple RGB LEDs, the calibration sequence of each RGB LED may be different to allow the network device 10 to determine the proper orientation.

Thus, in certain embodiments, the joining device 100 may transmit the calibration sequence, followed by the cryptographic key. The length of this key is protocol dependent. For Mesh provisioning, the authentication data maximum length is either 128 or 256 bits, depending on the protocol version used. However, in certain embodiments, the joining device 100 may transmit fewer bits if the full data length is not required for the level of security that is desired.

However, in other embodiments, it may be beneficial to create a more defined structure. This allows some flexibility in the size of the string that is transmitted by the joining device 100 and also allows the scheme to work with future protocol versions.

One well known method of storing or transmitting variable length data is the use of the type-length-value (TLV) format. In this TLV format, the transmitted data always includes the type of information being transmitted, the length of the data to be transmitted (if any), and the data itself (if any).

The following compact TLV definition can be used here:
A TLV is constructed using the same base-7 symbols the data is encoded with. In other words, septenary digits are used;
Type: One base-7 symbol is used to represent the type of that follows;
Length: Zero or more symbols represent the length of the data to follow; the number of symbols used to represent the length may depend on the type;
Data: Zero or more symbols represent the data contained in the TLV.

Using this format, the following set of TLVs may be created:

| | | Data Length | |
|---|---|---|---|
| TLV | Type Symbol | Symbols | Notes |
| Terminator | 0 | Zero | No associated |
| | | | data |
| ShortData | 1 | Two | Up to 49 data |
| | | | symbols |
| | | | follow |
| LongData | 2 | Three | Between 50 |
| | | | and 392 data |
| | | | symbols |
| | | | follow |
| DataCRC32 | 3 | Zero | 12 associated |
| | | | symbols |
| | | | always follow |

The other Type Symbols are not currently defined and may be used later to extend the messaging capabilities.

Note that while the TLVs are defined above using base-7, it is understood that these TLVs may also be used with a different numeric base, if desired.

An OOB message that is transmitted from the joining device 100 to the network device 10 will include one or more TLVs, transmitted one after another.

The following TLVs are defined to be included in OOB messages:
The Terminator TLV includes only the type symbol, without length or data symbols, and serves to indicate the end of the OOB message. Any septenary digits following the Terminator TLV are to be ignored.
The ShortData TLV type symbol is followed by two data length symbols, meaning that the length indicated can range from 1 to 49 given that two base-7 symbols can record 49 different values. Note that this is more than enough for encoding 128 bits of authentication data, as 46 septenary digits convert to roughly 128 bits.
The LongData TLV is followed by three data length symbols, which allows for recording of 343 different values. Given that the ShortData TLV can already be used to carry up to 49 symbols of data, the LongData TLV can be used to carry from 50 to 392 symbols, having the three length symbols represent values from 50 to 392 instead of 1 to 343.
The DataCRC32 TLV is followed by no data length symbols, as the length of the associated data is constant. Twelve data symbols follow; these are sufficient to record a 32-bit CRC (cyclic redundancy code) value that the receiver can use for checking the integrity of the immediately preceding data TLV.

When encoding lengths and data, the encoding can be least significant digit first (little endian) as well as most significant digit first (big endian), as long as both devices agree on the ordering.

As an example, consider an OOB message that carries the very short (and in practice, insecure) 16-bit hexadecimal authentication value 0xABCC without a CRC. This would be constructed as follows (in most significant digit first ordering):
“The hexadecimal digit string “ABCC” corresponds to the bit string “1010101111001100”
Which corresponds to the six-long septenary digit string “242136”
Which can be encoded as a ShortData TLV (type 1, length 06) as “106242136”
Which will be followed by the Terminator TLV that is a solitary “0” digit
Which results in the complete OOB message “1062421360”

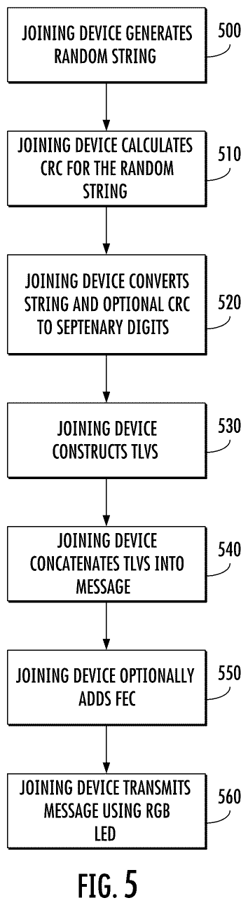

Having defined the data structures that are used, the process that the joining device 100 uses to send authentication data to the network device 10 will be defined and is shown in FIG. 5. First, as shown in Box 500, the joining device 100 will generate a random bit string of sufficient length (for example, 128 or 256 bits) to serve as the authentication data. As shown in Box 510, optionally, the joining device 100 will calculate a 32-bit cyclic redundancy checksum (CRC) on the authentication data. Next, as shown in Box 520, the joining device 100 will encode the bit string as a string of septenary digits. This is merely a number conversion from base-2 to base-7 and can easily be achieved even on limited hardware. Further, if a CRC was calculated, the device will encode that bit string as a string of septenary digits as well. Next, as shown in Box 530, the joining device 100 will construct two or three TLVs, these being:
Either a ShortData TLV or a LongData TLV, depending on how long the encoded authentication data string of digits is;
Optionally, a DataCRC32 TLV containing the encoding of the CRC value that was calculated
A Terminator TLV
   Next, as shown in Box 540, the joining device 100 will construct the OOB message to be sent by concatenating the aforementioned TLVs together into one string of septenary digits.

Note that if a method of forward error correction is used, the joining device 100 will apply a FEC encoder on the OOB message string of septenary digits, resulting in a new string of septenary digits that contains an FEC encoding of the original OOB message. This is performed after the OOB message is formed, as shown in Box 550.

Finally, as shown in Box 560, once the process of building the OOB message is completed, either FEC encoded or not, the OOB message is transmitted by toggling the color of the light source 170 as needed to generate the desired string. Once the transmission is completed, the joining device 100 turns the light source 170 off, if it was not yet off.

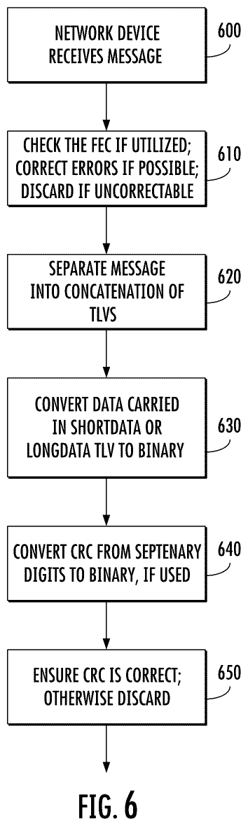

The network device 10, upon receiving the OOB message from the joining device 100 via its camera 70, performs a decoding process, which is shown in FIG. 6. First, using the camera 70, the network device 10 captures the OOB message transmitted from the joining device 100, as shown in Box 600. Next, as shown in Box 610, if a method of forward error correction was used by the sender, the network device 10 will decode the received string using the corresponding FEC decoder. If transmission errors are detected, they are corrected when possible. If there are too many errors to correct, the OOB message will be discarded.

Next, as shown in Box 620, the network device 10 will interpret the OOB message as a concatenation of TLVs and find out the boundaries of each TLV in the OOB message based on the type and length information contained in the TLVs. Note that if it cannot be done, the OOB message will be discarded. The network device should find either two or three TLVs in the OOB message, with:
The first TLV being either a ShortData TLV or a LongData TLV,
The middle TLV being a DataCRC32 TLV (when there are three TLVs), and
The final TLV being a Terminator TLV.

The network device 10 will convert the data found in the ShortData TLV or the LongData TLV from septenary digits to binary digits, as shown in Box 630. As noted above, this is a simple number conversion, from base-7 to base-2.

As shown in Box 640, if the optional DataCRC32 TLV is present in the OOB message, the network device 10 will convert the data carried in the DataCRC32 TLV from septenary digits to binary digits. Finally, as shown in Box 650, if the DataCRC32 TLV was present in the OOB message, the network device 10 will check that the binary CRC matches the binary authentication data. If it does not, the OOB message will be discarded.

Once the process completes, the network device 10 may make use of the authentication data during the pairing process. This will be described with respect to both Bluetooth LE and Bluetooth Mesh.

Note that as mentioned above, the processes described above may be performed using other than septenary digits. For example, in some embodiments, base 4 is used for ease of conversion to binary. Additionally, if multiple LEDS are used, or more than two color states are used, a base greater than 7 may be used.

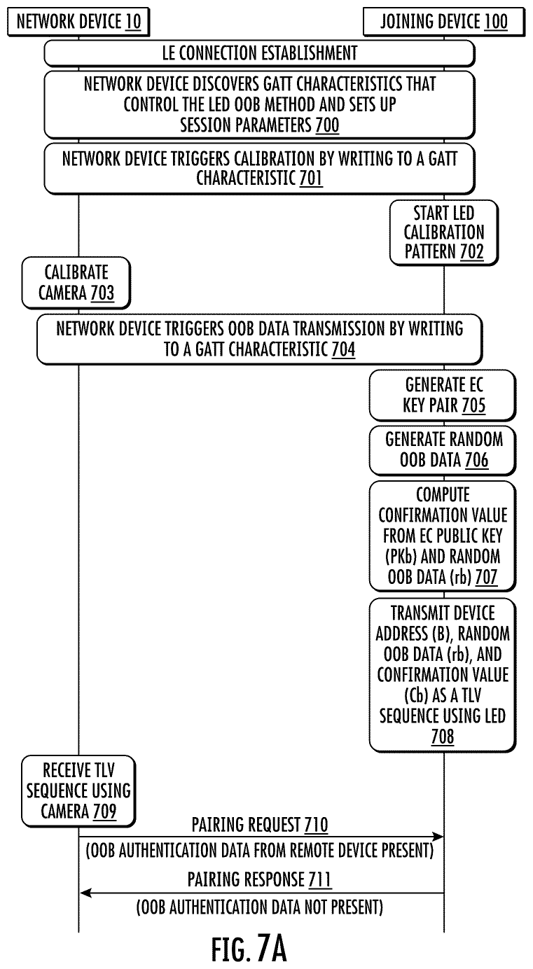

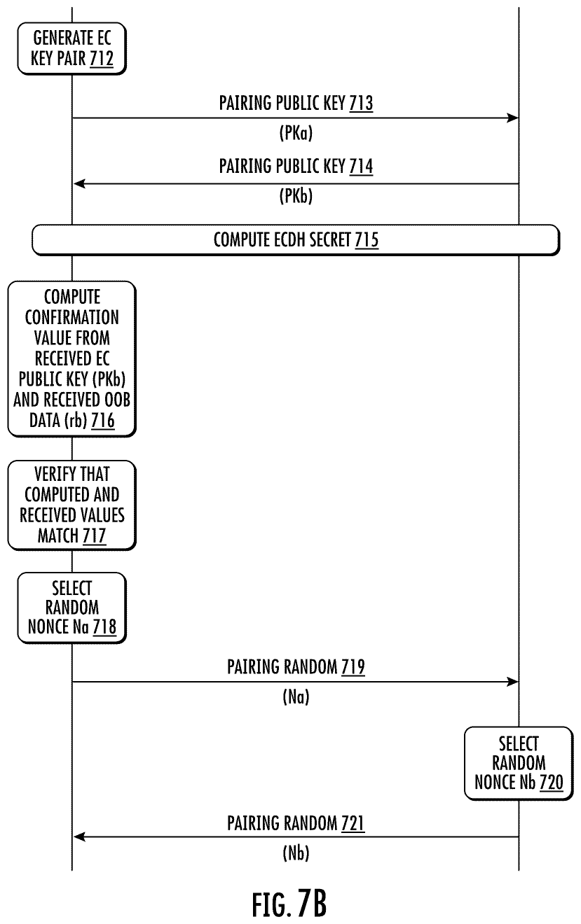

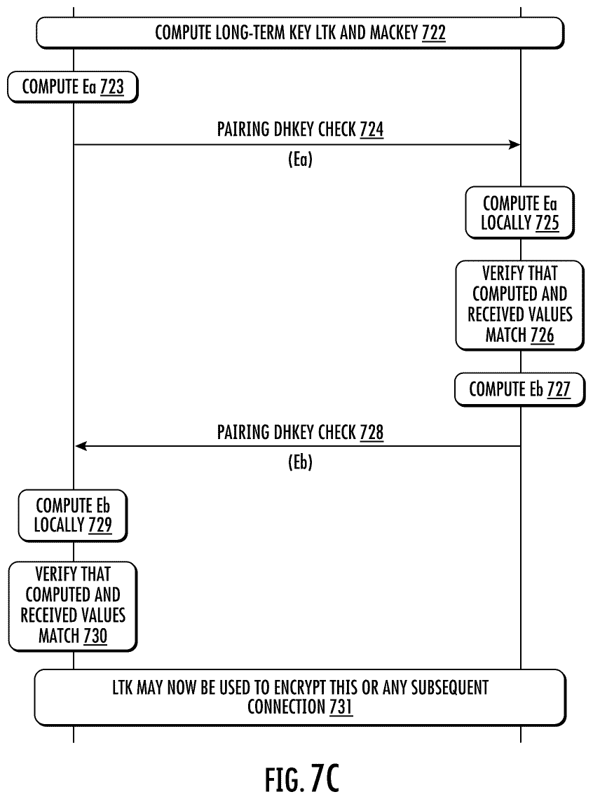

Referring to FIGS. 7A-7C, the Bluetooth LE Secure connections pairing is a multi-phase process. The two devices must form a connection in order to execute the pairing process. This is typically initiated by the network device 10, if the joining device 100 is a peripheral. The network device 10 may gain knowledge that the joining device 100 supports this OOB method in several ways. In one embodiment, after a connection is formed, the network device may perform a service discovery of the joining device's GATT services. The network device may then locate and obtain the service that provides information on the joining device's OOB capabilities (see line 700). In some embodiments, this same service can be used also to negotiate parameters related to the OOB data, such as the size of the random data or other parameters. This service may also be used by the network device to trigger the transmission of the calibration sequence, stop the calibration sequence and initiate the OOB transmission start.

Next, as noted above, the network device 10 may use the GATT services associated with the OOB method to initiate the calibration sequence (see line 701). In response, the joining device 100 may start transmitting a calibration sequence (see line 702). The network device 10 adjusts its camera settings based on the calibration sequence (see line 703). When complete, the network device 10 is successfully calibrated. In some embodiments, the network device 10 may use the GATT service to terminate the transmission of the calibration sequence. In other embodiments, the joining device 100 may stop transmitting the calibration sequence when it receives a command from the network device 10 (via the GATT services) to begin OOB transmission (see line 704).

The network device 10 may again utilize the GATT services to instruct the joining device 100 to transmit the joining device's Bluetooth address, the random data and a corresponding confirmation value (see line 704). In response, the joining device 100 stops transmitting the calibration sequence, if it has not yet done so. The joining device 100 and the network device 10 both include an ephemeral elliptic curve key, which allows the creation of a public key and a private key. The public key is available to any other device and allows decryption of a string that was encrypted using the corresponding private key. The joining device 100 generates an EC key pair (see line 705) and then generates random data (see line 706). This random number (rb) may be a fixed length, such as 128 bytes. Note that this random data is device unique, in that it is currently only known by this device. The joining device 100 then computes the confirmation value based on the EC public key (PKb) and this random data (see line 707).

The joining device 100 then constructs an OOB message as explained above that includes the Bluetooth address (B) of the device, random data (rb) and the confirmation value (Cb). This combination of the Bluetooth address (B), the random data (rb) and the confirmation value (Cb) may be referred to as device unique information. Thus, the joining device 100 may transmit an OOB message with two TLVs, a ShortData or LongData TLV, followed by a Terminator TLV (see line 708). Optionally, the joining device 100 may generate a CRC; in which case, the OOB message would also contain a DataCRC32 TLV before the Terminator TLV. Finally, as explained above, the joining device 100 may utilize FEC. The use of CRC and FEC may be negotiated based on parameters found in the joining device's GATT service.

The network device 10 then receives the OOB message using the camera and decodes the TLVs to obtain the random data and the confirmation value (see line 709).

At this point, the pairing process can begin. All transmissions after this point are performed using the Bluetooth network. This pairing process begins with the network device 10 transmitting, using Bluetooth, a Pairing Request (see line 710). This Pairing Request includes an indication that the network device already has OOB data from the remote device. The joining device 100 then replies, transmitting a Pairing Response (see line 711). Note that because the OOB data only travels from the joining device 100 to the network device 10, the Pairing Response indicates that it does not have OOB data from the remote device.

At this point, as shown in FIG. 7B, EC public key exchange is performed. The network device 10 generates its own EC key pair (see line 712). The network device 10 transmits its public key (PKa) to the joining device (see line 713). The joining device 100 respond by transmitting its public key (PKb) to the network device 10 (see line 714). Both devices may now compute the ECDH secret using their own private key, and the other nodes public key (see line 715).

The network device 10 then validates the confirmation value that it received from the joining device 100 in the OOB message (see line 716). This is done using the public key (PKb) that was received in-band and the random data (rb) that was received out-of-band. If the confirmation value received in the OOB message matches that generated by the network device 10 using the public key and the random data (see line 717), the pairing process may continue. Otherwise, the pairing process may be terminated. The network device 10 then selects a new random nonce (Na) (see line 718). This new random nonce (Na) is transmitted to the joining device 100 (see line 719).

The joining device 100 then selects a random nonce (Nb) (see line 720). This random nonce (Nb) is then transmitted to the network device 10 (see line 721).

Once the random nonces have been exchanged, the rest of the pairing process may proceed as shown in FIG. 7C. Both devices may now compute the long-term key (LTK) and Mackey, (see line 722). The network device 10 computes a confirmation value (Ea) (see line 723). This confirmation value (Ea) may be computed based on the MacKey, Na, Nb, the two Bluetooth addresses, and the value of rb. Ea is then transmitted to the joining device 100 (see line 724). The joining device 100 also computes the expected value of Ea locally (see line 725). It then compares its locally computed value of Ea to that received from the network device 10 (see line 726). The joining device 100 computes a confirmation value (Eb) (see line 727). This confirmation value (Eb) is also computed based on the MacKey, Na, Nb, the two Bluetooth addresses, and the value of rb. Eb is then transmitted to the network device 10 (see line 728). The network device 10 also computes the expected value of Eb locally (see line 729). It then compares its locally computed value of Eb to that received from the joining device 100 (see line 730). If both checks are correct, the long term key may now be used for this and any subsequent connection (see line 731).

Note that there are some variations to the pairing process described above. For example, while the Bluetooth LE specification mandates 128 bits for the random data and the confirmation value, the joining device 100 may transmit a shorter length random data, such as 64 bits. Both devices need to be aware of this modification, which may be achieved by using settings contained in the GATT service of the joining device 100. In this case, both devices would pad the random data with 64 zeros to arrive at the 128 bit value.

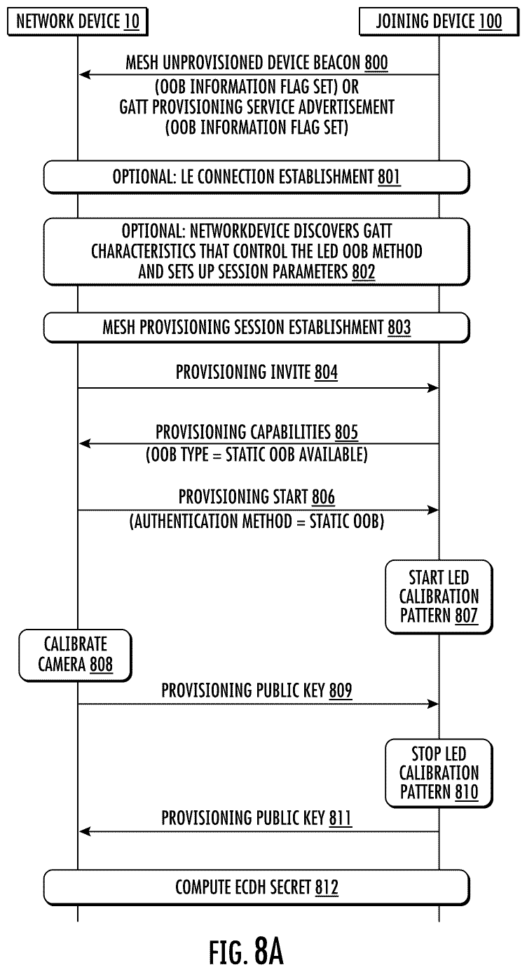

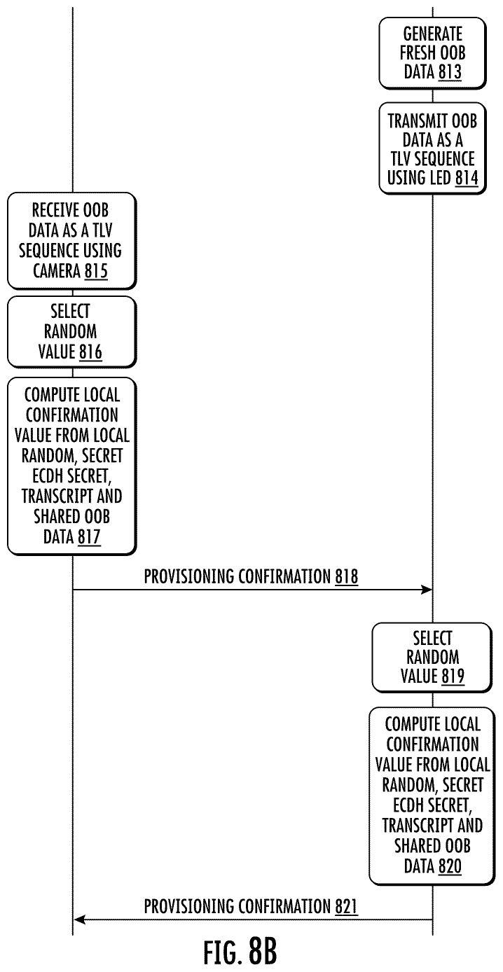

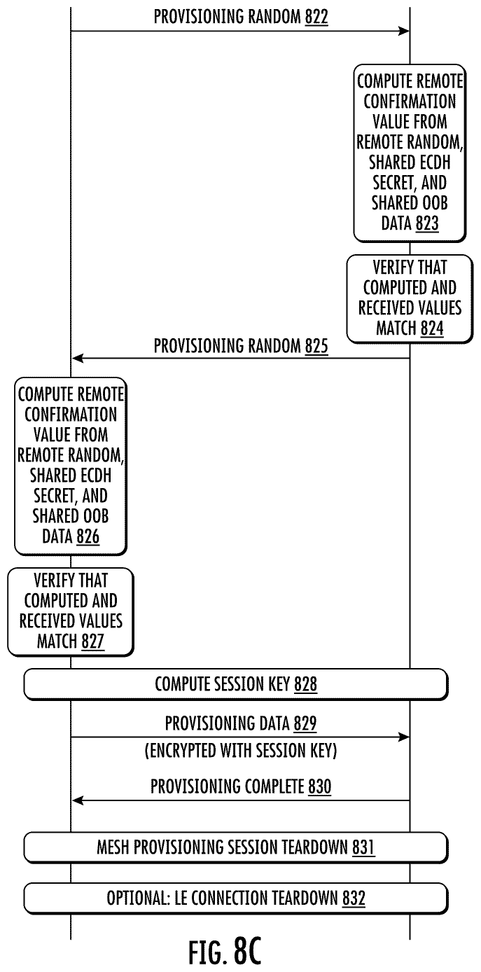

Having described how the OOB message may be incorporated into Bluetooth LE Secure Connections, its use with Bluetooth Mesh provisioning will be described next with reference to FIGS. 8A-8C. Note that much of this process is the same as is usually used with Bluetooth Mesh. Only the inclusion of indications and the OOB messages are different.

First, the joining device transmits an unprovisioned device beacon (see line 800) to indicate it can be provisioned using broadcast advertisements. Alternatively or additionally, the joining device 100 may indicate that it is available for GATT-based provisioning by service advertising its GATT provisioning service. Additionally, the joining device 100 provides an indication that it supports this OOB method. This may be achieved by setting the Reserved for Future Use (RFU) bit, or by setting the “Other” bit in the OOB information field in the unprovisioned device beacon. Note that a similar bit may be set in the service advertising of the GATT provisioning service as well. Note that optionally, a LE connection may be established as well (see line 801).

If the network device 10 chooses to use the GATT provisioning service to provision the joining device 100, after a connection is formed, the network device may perform a service discovery of the joining device's GATT services, locate and obtain the service that provides information on the joining device's OOB capabilities, and negotiate parameters related to the OOB data, such as the size of the random data or other parameters in the same manner as is described above for LE pairing (see line 802).

The network device 10, recognizing that the joining device 100 supports this OOB method, establishes a Mesh provisioning session using the chosen provisioning method (either GATT-based or advertisement-based) (see line 803). The network device 10 transmits an Invite PDU to the joining device (see line 804). The joining device 100 responds with a Capabilities PDU (see line 805). The Capabilities PDU may include an indication that OOB authentication is supported.

The network device 10 then responds with a Start PDU (see line 806). In this Start PDU, the network device selects OOB authentication.

In response, the joining device 100 begins transmitting the calibration sequence described above (see line 807). The network device 10 adjusts its camera settings based on the calibration sequence. When complete, the network device 10 is successfully calibrated (see line 808).

Once complete, the EC key exchange may take place. The network device 10 transmits its provisioning public key to the joining device 100 (see line 809). The receipt of the provisioning public key from the network device 10 causes the joining device 100 to stop transmitting the calibration sequence (see line 810). Additionally, the joining device 100 responds with its provisioning public key (see line 811). Once the public keys are exchanged, both devices can independently compute an ECDH shared secret to be used in the following transactions (see line 812).

At this time, as seen in FIG. 8B, the joining device 100 prepares the OOB message. First, the joining device 100 generates random data (see line 813) to be used as the OOB authentication value. The joining device 100 then constructs the OOB message using the OOB authentication value. As noted above, this is device unique information. In some embodiments, the OOB message comprises two TLVs; a ShortData or LongData TLV for the OOB authentication value, and a Terminator TLV. In other embodiments, the joining device 100 may include a CRC, in which case a third TLV, the DataCRC32 TLV, will also be transmitted before the Terminator TLV. The joining device 100 then transmits the OOB message (see line 814). This OOB message is then received by the network device 10 using the camera (see Line 815).

After receipt of the OOB message, the network device 10 chooses a random value (see line 816) and computes a confirmation value from the ECDH shared secret, transcript of the messages exchanged so far, the OOB authentication value that was received, and the chosen random value (see line 817). It then transmits a Confirmation PDU to the joining device 100 (see line 818). The Confirmation PDU includes the confirmation value used by the network device 10. The joining device 100 chooses its own random value (see line 819), and computes its own confirmation value (see line 820) using the random value, the shared ECDH secret, the same message transcript as above, and the OOB authentication value. The joining device 100 then responds with Confirmation PDU as well (see line 821). As shown in FIG. 8C, the network device 10 then transmits a Random PDU, which contains the random value it has chosen (see line 822). The joining device 100 uses the random value it received in the Random PDU to locally compute the expected confirmation value for the network device 10 (see line 823). This locally computed confirmation value is then compared to that sent by the network device 10 in the earlier Confirmation PDU (see line 824). The joining device 100 then also transmits a Random PDU (see line 825) containing the random value it chose earlier. The network device 10 then locally computes the expected confirmation value for the joining device 100 (see line 826) and compares that to the data that was received in Confirmation PDU sent earlier by the joining device 100 (see line 827). As the OOB authentication value is an input to the confirmation value calculations, a device that does not have access to the correct value would be very unlikely to arrive at the correct answer. Thus, comparing the locally computed value to the value received can be used to authenticate the other device.

The two devices then compute a session key (see line 828) using the ECDH shared secret, the same message transcript as above, and the random numbers. Finally, the network device 10 transmits a Provisioning Data PDU to the joining device (see line 829), which is encrypted using the session key. The joining device 100 responds with a Provisioning Complete PDU (see line 830). At this point, the provisioning session is complete and may be torn down (see line 831). Additionally, if a LE connection was previously established, that can be torn down at this time (see line 832).

As explained above, authentication data having a shorter length may be used in the OOB message, as long as both devices are aware of this modification.

The present system and method has many advantages. First, it allows the transmission of the information from the joining device to the network device with no involvement of the user. Note that the user is not required to manually enter any information into the network device. Further, the user is not required to scan a QR code that accompanied the new joining device.

The ability to eliminate the QR code simplifies the manufacturing process in that the manufacturer no longer has to ensure that the correct QR code accompanies the device throughout the manufacturing process. It also makes it easier for the user to re-provision the device. In certain embodiments, the user must keep the QR code or the device cannot join any other networks.

Further, the present system and method allow for increased security. The OOB message described herein may only be received within line of sight. In contrast, RF communications can travel through walls for easier interception by a malicious actor. Additionally, QR codes/serial numbers can be peeked at by simply opening the box in the store that contains the new device.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A method of allowing a joining device to join a Bluetooth network, the method comprising:
transmitting from the joining device, an out of band (OOB) message containing device specific information associated with the joining device, wherein the joining device utilizes a multi-color light transmitter to transmit the OOB message, and wherein the OOB message is encoded by transitions in a state of the multi-color light transmitter;
receiving, at the network device, the OOB message; and
using information in the OOB message to perform a joining process.

2. The method of claim 1, wherein the multi-color light transmitter comprises a red green blue (RGB) LED, wherein there are at least 8 LED states.

3. The method of claim 2, wherein 8 LED states are used, which create 7 possible transitions, and all data in the OOB message is encoded using base-7.

4. The method of claim 1, wherein each color component of the RGB LED has at least three states; an on state, an off state and at least one state between the on state and the off state; and wherein there are at least 27 LED states.

5. The method of claim 1, wherein prior to transmitting the OOB message, the joining device transmits a calibration sequence to allow the network device to calibrate a camera.

6. The method of claim 1, wherein the OOB message is structured as a plurality of TLVs (type-length-value).

7. The method of claim 1, wherein the OOB message includes a cyclic redundancy code.

8. The method of claim 1, wherein the OOB message is encoded using a forward error correction (FEC) mechanism.

9. The method of claim 1, wherein the network device queries GATT services in the joining device to determine if the joining device is capable of transmitting the OOB message.

10. The method of claim 1, wherein the Bluetooth network comprises a Bluetooth LE network and the joining process comprises a LE Secure Connections pairing process.

11. The method of claim 10, wherein the network device transmits a GATT request to the joining device to initiate transmission of the OOB message.

12. The method of claim 1, wherein the Bluetooth network comprises a Bluetooth Mesh network and the joining process comprises a provisioning process.

13. The method of claim 12, wherein the joining device transmits the OOB message to the network device after the network device transmits a Provisioning Start PDU to the joining device.

14. A Bluetooth system, comprising:
a network device comprising a camera; and
a joining device comprising a multi-color light transmitter;
wherein the joining device is configured to transmit an OOB message using the multi-color light transmitter;
wherein the data is encoded by transitions in a state of the multi-color light transmitter;
wherein the network device is configured to receive the OOB message using the camera; and
wherein information in the OOB message is used by the network device to perform a joining process.

15. The system of claim 14, wherein the OOB message transmitted by the joining device is structured as a plurality of TLVs (type-length-value).

16. The system of claim 14, wherein the multi-color light transmitter comprises a RGB LED, wherein there are at least 8 LED states.

17. The system of claim 16, wherein 8 LED states are used, which create 7 possible transitions, and all data in the OOB message transmitted by the joining device is encoded using base-7.

18. The system of claim 14, wherein the OOB message includes a cyclic redundancy code.

19. The system of claim 14, wherein the OOB message is encoded using a forward error correction (FEC) mechanism.
